(19) United States
(12) Patent Application Publication
(10) Pub. No.: US 2025/0215864 A1
(43) Pub. Date: Jul. 3, 2025

(54) GRAVITY MOTOR

(71) Applicant: JAY PIRINCCI, New York, NY (US)

(72) Inventor: JAY PIRINCCI, New York, NY (US)

(21) Appl. No.: 18/987,688

(22) Filed: Dec. 19, 2024

(51) Int. Cl. F03G 7/10; F03G 3/00

(52) U.S. Cl. CPC F03G 7/10; F03G 3/094; F05B 2210/11; F05B 2260/02

(57) ABSTRACT

This invention is an energy or electricity production process or system that converts mechanical energy into electrical energy.

Gas (air), liquids and solids, the 3 states of matter available everywhere on earth at all times are used together with the scientific principles of gravity and buoyancy in an enclosed 2-3 chamber tube within an air lock or vacuum created by sealed functional and expandable valves (to maintain a liquid level in the liquid chamber to float the weight that has dropped down by gravity in gravity chamber up to the top defying gravity and completing the revolution to start again) using a revolving chain assembly to create a system with a circulating solid dense mass that will turn a generator shaft similar to the pistons in a motor to generate electricity and power. Gravity will always be available everywhere at anytime as a constant force downward on earth. All liquids each with their own co-efficiency of buoyancy level (mercury having the highest force to push solids upward) will always have a natural buoyancy pushing any solid mass upward to defy gravity.

When an air lock or vacuum has been established by using closures, doors and functional valves in a sealed tube filled with liquid, then solid masses of any weight can be placed in these liquids to use their power of buoyancy to force the solid upward and start the whole process over again like a motor.

### BACKGROUND

In the past 100 years it has been the mission of industries, governments and humanity to generate as much energy and power as necessary to run engines and machines to develop civilization to the level we have achieved so far but also to find methods to reduce emissions and waste from burning the toxic chemicals and fuels needed to generate that needed power.

### SUMMARY OF OPERATING PRINCIPLE & FIELD

### Gravity+Buoyancy=Free Energy

### Free—Free Endless Energy Everywhere

In a 2 chamber design, weights or masses circulate like pistons using gravity to drop down in one chamber and buoyancy of liquids in an air locked vacuum 2^{nd} chamber to rise up (by means of 2 doors opening and closing to maintain one liquid level without replacement, for buoyancy-see door explanation) turning a generator shaft to create a motor producing as much electrical power as needed for free.

Many sections each with 2 chambers will be used to create an alternating energy process where one section will generate power with gravity in the gravity chamber from a dropping weight while in an attached section a weight rises up from the buoyancy of a liquid in the liquid chamber without any energy input and any disruption of power. Both chambers of each section are connected together with a cable to a mechanism consisting of a 2 wheel/pulley/gear at the top and bottom whereby the circulation of the cable with the attached weight turns these wheels that are connected to a generator shaft revolving up and down similar to a motor piston. Mechanical energy converted to electrical energy.
No fuel—Chemicals—Combustion—Emission—Pollution
No Sun, Wind, Water necessary
Build Anywhere
3 States of Matter, Solid, Liquid, Gas Combined with two Forces—Gravity and Buoyancy to generate as much free power as necessary
No dams or reservoirs which need constant replenishment of water and satisfactory supportive climate conditions.

MASS×GRAVITY×HEIGHT=ENERGY=ALTERNATOR OUTPUT (RPM—POLES—GEAR—RATIO—HEIGHT)

### DRAWINGS & SPECIFICATIONS

### 4 Drawing Sheets—3 Specification Sheets

### Specifications

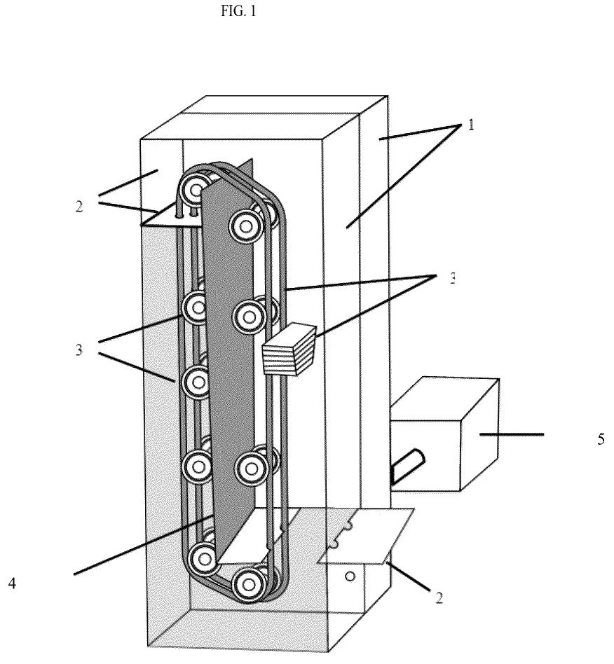

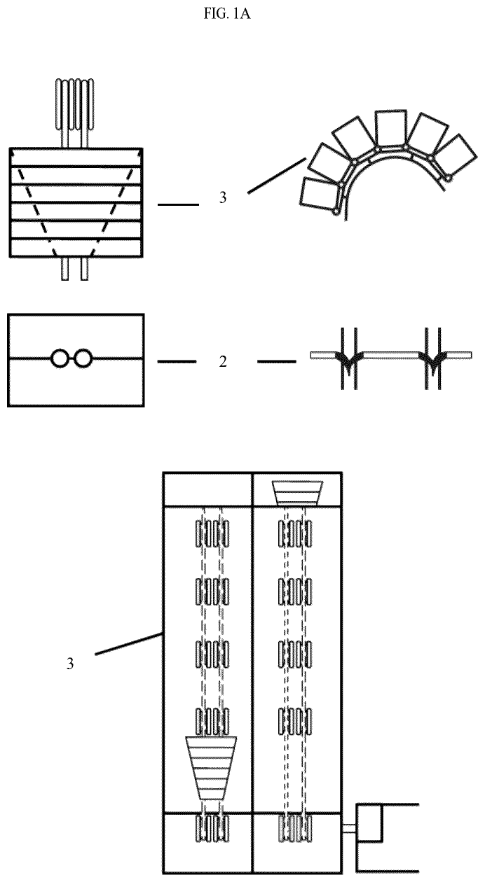

FIG. 1—DEVICE DESIGN & OPERATING PRINCIPLE

SIDE PERSPECTIVE

FIG. 1a DEVICE DESIGN & OPERATING PRINCIPLE

FRONT VIEW ELEVATION—WEIGHTS DOOR, CABLE DESIGN

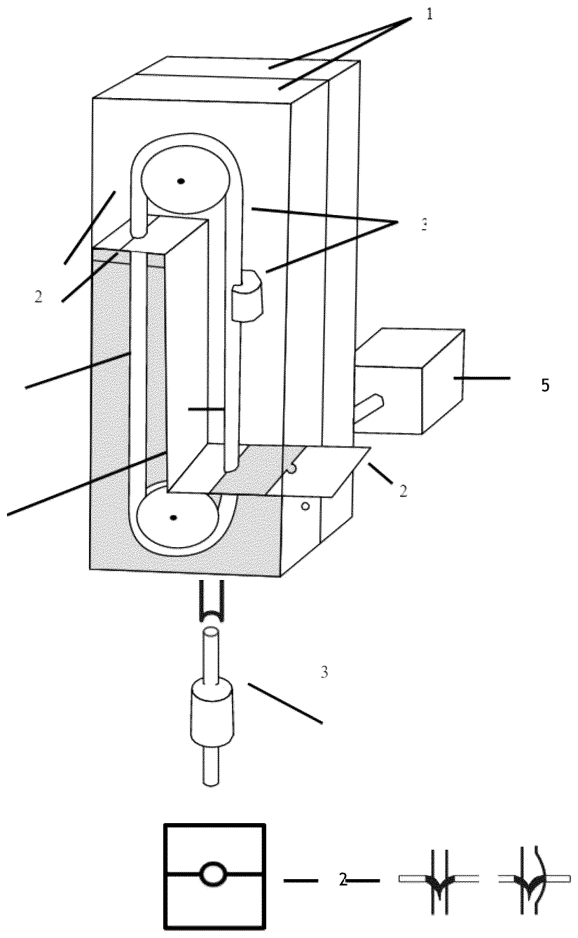

FIG. 2 DEVICE DESIGN & OPERATING PRINCIPLE

VERSION 2—SINGLE CABLE—SAME PRINCIPLE

SIDE PERSPECTIVE—WEIGHTS DOOR, CABLE DESIGN—DETAIL CABLE DOOR

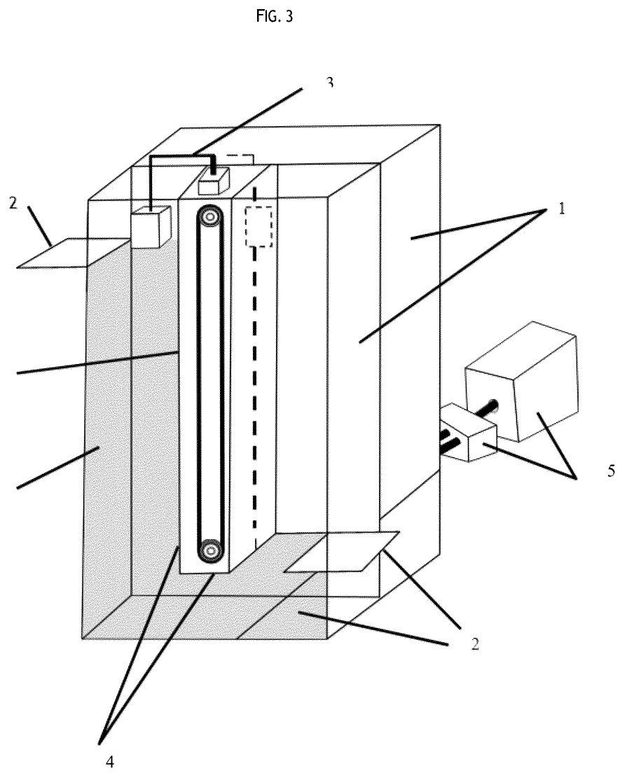

FIG. 3 DEVICE DESIGN & OPERATING PRINCIPLE

VERSION 3—CRANE AT TOP CHAMBER TRANSFER

PERSPECTIVE OF CRANE TRANSFER AT TOP

### DESCRIPTION OF PARTS 1-6

### 1—Device Design & Operating Principle—Detail

In a 2 chamber design, weights or masses circulate like pistons using gravity to drop down in one chamber and buoyancy of liquids in an air locked vacuum 2^{nd} chamber to rise up (by means of 2 doors opening and closing to maintain one liquid level without replacement, for buoyancy—see door explanation) turning a generator shaft to create a motor producing as much electrical power as needed for free.

Many sections each with 2 chambers will be used to create an alternating energy process where one section will generate power with gravity in the gravity chamber from a dropping weight while in an attached section a weight rises up from the buoyancy of a liquid in the liquid chamber without any energy input and any disruption of power. Both chambers of each section are connected together with a cable to a mechanism consisting of a 2 wheel/pulley/gear at the top and bottom whereby the circulation of the cable with the attached weight turns these wheels that are connected to a generator shaft revolving up and down similar to a motor piston. Mechanical energy converted to electrical energy.

Each section has 2 chambers—

Front right chamber is open air-gravity-down chamber

Rear left chamber is liquid for buoyancy up chamber

Many attached sections can be used depending on power demand.

One section has weight dropping downward from gravitational pull in the gravity chamber while in the second section the liquid chamber has buoyant liquid thrusting weight upward using weights attached to cables to rotate a generator shaft with a gearbox producing constant power. The gearbox will act similar to a bicycle chain switching gears from one section to another always generating power. The gearbox will have alternating shafts switching gears to insure engagement to the downward section for continuous power.

### 2—Air Sealed Doors

Air sealed doors will have round openings with special gaskets allowing cables to pass thru while creating a vacuum and air lock to maintain a high liquid level in the liquid chamber 2 but also sliding open for weights to pass thru in one chamber while in the other chamber remaining closed to still maintain airlock and vacuum.

Version 2—The doors will be closed permanently if a special expandable gasket is designed and used to allow the cable and then the weight to pass thru the same hole and expandable gasket. Even if there is a little insignificant amount of seepage of liquid from the gasket to decrease buoyancy, it can easily be refilled from the nozzle above at top in chamber 2 instead of the wasteful energy needed for pumping or refilling reservoirs to higher levels as in other water or liquid power energy generated systems.

Cable design version-Diverter at bottom helps change and direct weight direction into chamber 2 before it begins floating upward.

### 3—Weights—Cables—/Straps—Wheels/Guids/Pulley—Liquid

Increasing size & number of weights and height will generate more electric power.

Adjusting density and coefficiency of the liquid and density of the material of the weights will easily determine buoyancy power of the weights for flotation upward.

Every liquid has a coefficiency of buoyancy. Mercury has the highest.

Energy & liquid buoyancy charts will be available.

Weights can be cylinders or flexible containers or bags filled with many types of dense buoyant materials for gravity weight or buoyancy lift.
The number of cables can be one or increased according to weight needed. The cables can be Teflon coated with gear and chain design to maintain air seal passing thru closed doors.
Weights will be shaped narrower at bottom creating a much easier entry into liquid.
Rollers, guides or wheels will be designed to work with the cable design and material other or similar type of attachments according to the rollers or wheel size that will allow the weight to turn and bend at the top or bottom and still maintain air seal.
The excess energy from the electric grid can supply the small amount of energy needed for the few feet of required lift height above door at top to thrust and necessary.
Crane design-no opening for cable will be needed in air sealed doors since the air seal will be created by closing door at top of liquid chamber allowing door in gravity chamber to be opened for weight to pass when weight is released from cable in gravity chamber whereby floating upward to top of liquid chamber. When it reaches the top, the door in gravity chamber will close to prevent water flow outward. When crane picks up weight to transfer into gravity chamber, the process starts over again.

### 4—Air—Liquid Divider

Air-liquid divider will separate the 2 chambers.
A filling nozzle at the top of chamber 2 for any loss of liquid or for replacing dirty liquid.
An overflow nozzle at the bottom of chamber 1 will also be available.

### 5. Gear Box—Chain—

Gearbox—design similar to a bicycle chain changing gears from one section to another located at the bottom shaft connected to the generator. As the weight rises in one section and drops in the other section the mechanism always switches to the gear chain where the weights are dropping to insure continuous power.
Design of gear box will be used with the cable transfer design at the top where the cable will always switch in the gearbox to the cable dropping down to insure continuous power.
Attached cable can also remain in tact with one gear continuously turning while the crane picks up and engages with weight to move it into second chamber for it to drop. The weight rising will rise on its own without any connection to cable.
2 cables and 2 cranes. Cables attached to wheel wrap around wheel at bottom and are released to roll up and rise up or drop and roll down, each in opposite direction while crane is lifting weight and attaching weight to end of cable to drop downward. At least one weight is always dropping to supply continuous power.

1. This invention is an energy or electricity production process or system that converts mechanical energy into electrical energy.
Gas (air), liquid and solid, the 3 states of matter available everywhere on earth, are used together in an enclosed 2-3 chamber tube to create a circulating solid dense mass which will turn a generator shaft similar to the pistons in a motor to generate electricity and power.
Gravity will always be available everywhere at anytime as a downward force on earth.
All liquids will always have a natural buoyancy pushing any solid mass upward.
Gas, air and liquids will always be available to create an air-liquid binding force reaction to create an air lock or vacuum to defy gravity.
When an air lock or vacuum has been established by using closures, doors and functional valves in a sealed tube filled with liquid, then solid masses of any weight can be placed in these liquids to use their power of buoyancy to force the solid upward. Each liquid has its own coefficiency of buoyancy where denser liquids (mercury being the densest) have more force to hold and push solids upward.
If a device is created to use one tube for the downward force of a solid mass falling from the top of the tube using gravity where it will be attached to another tube filled with a liquid to use a liquid's buoyancy force to thrust the same solid mass upward from the bottom, then we will have established the principles of an engine where the circulating masses down (gravity) and up (liquid buoyancy) generate power or electricity without using any fuels, chemicals, combustion, emissions/pollution or energy input. The liquids will never have to be replaced.
The principle method of my invention gravity-downward.
The buoyancy of an air-locked liquid in a vacuum-upward will always be the same to protect my invention even if there is different mechanisms or adjustments available to help move and transfer the solid masses vertically or horizontally in a more efficient manner.
If a device is created to use one tube for the downward force of a solid mass falling from the top of the tube using gravity where it will be attached to another tube filled with a liquid to use a liquid's buoyancy force to thrust the same solid mass upward from the bottom, then we will have established the principles of an engine where the circulating masses down (gravity) and up (liquid buoyancy) generate power or electricity without using any fuels, chemicals, combustion, emissions/pollution or energy input. The liquids will never have to be replaced.
Total Design Explanation
In a 2 section tube design where each tube has 2 chambers, a solid mass or weights connected to a cable or chain circulate like pistons, one in an open enclosure chamber 1 dropping downward from it's top using gravity into an attached air sealed (air lock/vacuum) liquid chamber 2 from it's bottom whereby floating upward using the buoyancy of liquids.
The liquid filled air locked chamber 2 maintains the liquid level by means of 2 doors, one at top of chamber 2 to create an air lock and the other at the bottom of chamber 1 when the top door in chamber 2 opens to allow weights to pass thru, this chamber 1 door closes briefly to Hold the water level. The doors open & close to create and maintain the air lock and liquid level allowing the sold mass to circulate without replacement of the liquid for buoyancy-see door explanation detail where doors have compressible and expandable rubber edging that allows the teflon coated cable to pass thru at all times while maintaining a sealed tube with an air lock or vacuum to keep the liquid level at the same level without replacement. The doors will open only to allow the weights to pass thru.
There are 2 sections because when one section has the weight dropping in it's chamber 1, the second section will have the weight rising up in
It's liquid filled chamber 2 creating a continuous generation of power Without disruptions. The generator shaft will easily switch gears using a gearbox from one section to another section or sections. Power can be increased by adjusting the sections height or volume or by adding more sections depending on the demand for power.
This method acts like a motor to convert mechanical energy into electrical energy generating as much clean electrical power as needed for free.
The principle method of my invention gravity-downward.
The buoyancy of an air-locked liquid in a vacuum-upward will always be the same to protect my invention even if there is different mechanisms or adjustments available to help move and transfer the solid masses vertically or horizontally in a more efficient manner.
Mass×gravity×height=energy=alternator output (rpm—poles—gear ratio—height)=kw
No fuel—chemicals—combustion—emissions—pollution—
Build anywhere—
3 states of matter solid, liquid, gas combined with two forces, Gravity—Buoyancy.

2. Another revised method would be using more or less number of cables.

3. Another revised method would be using more or less number of doors
To maintain air seal to create the air lock needed to hold the water in place for the weight to float back up to the top to start the process all over again dropping down with gravity and floating up with fluid buoyancy while turning the shaft of a generator to produce electric power.

4. Another revised method would be using a crane to transfer weight at the top from one chamber to the other.

5. Another very similar alternative method with the same exact concept I am proposing along with my main invention is using more functional expandable valves or gaskets to allow the passage of weights without the use of doors

6. Use of a crane at the top to move the weights from the liquid buoyancy chamber to the empty gravity chamber gravity—downward—and—an airlock vacuum holding a liquid creating a buoyancy upward.

7. There maybe many simple mechanisms, contraptions, functional and expandable valves, adjustments or sizing used in between to implement this process of transferring the solid mass in one enclosure downward using gravity and another enclosure upward using buoyancy moving the solid mass vertically or even horizontally but our method and principle of gravity down and buoyancy up we have proposed will always be the same to protect our invention from any modifications or adaptations.
